(19) United States
(12) Patent Application Publication
(10) Pub. No.: US 2012/0066003 A1
(43) Pub. Date: Mar. 15, 2012

(54) AUTOMOBILE SALES TRAINING AND PROMOTION SYSTEM

(76) Inventors: Ronald L. Collier, Memphis, TN (US); Chadwick J. Collier, Collierville, TN (US)

(21) Appl. No.: 13/049,836

(22) Filed: Mar. 16, 2011

Related U.S. Application Data
(63) Continuation-in-part of application No. 12/435,645, filed on May 5, 2009, now abandoned.
(60) Provisional application No. 61/057,233, filed on May 30, 2008.

(51) Int. Cl. G06Q 30/06; G06Q 10/06; G06Q 30/02; G06Q 10/00; G06Q 50/00; G06Q 40/08

(52) U.S. Cl. 705/4; 705/26.62; 705/14.55; 705/26.64; 705/7.11; 705/7.15

(57) ABSTRACT

The sales of automobiles are promoted by providing to a customer a portable media player including a user interface permitting the customer to selectively play one or more walkaround instruction files so that the customer may engage in one or more guided walkaround examinations of vehicles without the presence of a salesperson. The user interface further permits the customer to send a wireless signal requesting salesperson assistance. In response to such a signal, the salesperson engages in face-to-face interaction with the customer. The training of sales personnel may be enhanced by the same or similar portable media player as is provided to the customer, allowing the sales personnel to selectively play one or more sales training files. The media player may signal a base computer of the completion of selected training files, allowing automobile dealership management to track sales training.

### CROSS-REFERENCES TO RELATED APPLICATIONS

This application is a continuation-in-part of pending U.S. patent application Ser. No. 12/435,645, filed May 5, 2009, which claims benefit of U.S. Provisional Patent Application Ser. No. 61/057,233, filed May 30, 2008, both of which are incorporated herein by reference.

### BACKGROUND OF THE INVENTION

1. Field of the Invention

The present invention relates to systems and methods for promoting the sales of automobiles and training and tracking the training of automobile sales personnel.

2. Description of the Prior Art

The purchase of a new automobile is one of the largest financial transactions that most consumers engage in. For many consumers it is an experience fraught with fear and frustration over the personal interactions necessary with sales personnel of the auto dealership.

Typically the potential purchaser walks onto a car lot and is immediately confronted by sales personnel who are ready, willing and able to escort the customer through the sales lot and explain the features and advantages of each available model.

Some customers, when working directly with a specific sales person, may feel that their “assigned” sales person does not adequately understand the features, benefits and limitations of the model of car they are interested in purchasing. These customers may be turned away from the dealership, as a whole, due to the varied training among the sales personnel rather than ask to work with a different sales person. One dilemma faced by the automobile dealer is how to adequately train and track the training of their sales personnel.

Many potential customers just want to look, and choose to wander through the display room or sales lot themselves. Another dilemma faced by the automobile dealer is how to accommodate the desires of some customers to look around without being escorted by a sales person, and yet take full advantage of the opportunity to make a sale to the customer.

One partial solution to the problem has been online sales promotions that allow customers to view photographs of automobiles on the dealer's website. Although it is possible to consummate an actual purchase of an automobile online, for most customers the final purchase is still going to require a visit to the dealership and an actual hands on examination of the automobile and a test drive frequently is desired.

Thus there is a continuing need for improved systems and methods for promoting the sales of automobiles which accommodate the desires of many customers to have the freedom to examine the various automobiles without the assistance of a sales person, and yet which allow the sales personnel to intervene at appropriate times when desired by the customers and which allow the dealer to follow up on the customer visit. There is also a need for improved systems and methods for training and tracking the training of sales personnel, thereby assuring uniform training across the automobile dealership.

### SUMMARY OF THE INVENTION

The present invention provides systems and methods for promoting the sales of automobiles through the use of suitably programmed portable media players such as personal digital assistants, smartphones, tablets, and the like, that will guide the customer through unescorted walkaround examinations of the automobiles without the presence of a salesperson, and which will aid the customer in soliciting sales person assistance at the appropriate times. The systems and methods also permit follow up with the customer after the visit to the dealer.

The present invention further provides systems and methods for training sales personnel, by using suitably programmed portable media players, such as personal digital assistants, that will guide the sales personnel through the features of certain makes and models of automobiles. The sales personnel may sign into a main computer system to use these media players. The media players will send (for example, wirelessly or when docked to the main computer system) a record of completion of the training to the main computer system to track sales personnel training. The main computer system may further include features for testing sales personnel, prompting for periodic retraining (for example, at the introduction of a new model year), and alerting the automobile dealership when training goals have or have not been met. The training may include any training related to the particular roles and responsibilities. For example, the training may include training on the features of the cars on the dealership lot (by, for example, viewing the media player in the same manner as a customer). The training may also include internal dealership-based media training (videos not available to the customers), such as service department training, financing training, incentive training, and the like.

In one embodiment a method of promoting the sales of automobiles is provided. Each customer visiting the dealership who wishes to engage in unescorted examination of the vehicles is provided with a portable media player or personal digital assistant (PDA) which includes a user interface permitting the customer to selectively play one or more walkaround instruction files so that the customer may engage in one or more guided walkaround examinations of vehicles without the presence of a salesperson. In some embodiments, instead of receiving a portable media player from the dealer, the customer may use their own smartphone having an application previously downloaded thereupon. In this embodiment, the smartphone may send and receive data from the base computer, for example, via a wireless carrier's data service. The portable media player/PDA further permits the customer to send a wireless signal requesting salesperson assistance when desired. In response to the wireless signal requesting salesperson assistance, a salesperson engages in face-to-face interaction with the customer to provide additional information and/or to assist the customer with a test drive of the vehicle.

In another embodiment of the invention a system for promoting the sales of automobiles is provided to automobile dealers. The system includes a base computer having a wireless communication capability, and a plurality of portable media players/PDAs, each portable media player/PDA also having a wireless communication capability. Each of the portable media players includes a user interface which includes a plurality of selectable inputs each corresponding to a walkaround instruction file for an identified model of automobile, so that a customer may select playback of one or more of the walkaround instruction files. The user interface further includes an additional selectable input for sending a wireless signal to the base computer to request salesperson assistance. The base computer may receive content in a variety of ways. For example, the base computer may receive content by making a call via an application programming interface (API) to a content server.

Accordingly, it is an object of the present invention to provide systems and methods for promoting the sales of automobiles.

Another object of the present invention is to provide a method of promoting the sales of automobiles utilizing a portable media player/PDA which aids the customer in unescorted viewing of the automobiles, and which permits the customer to send a wireless signal requesting salesperson assistance.

Still another object of the present invention is the provision of systems for allowing dealers to implement improved methods of promoting the sales of automobiles which systems include a base computer and a plurality of portable media players/PDAs for use by the customers.

And another object of the present invention is the provision of systems and methods for improved follow up with customers who have visited the dealership. The base computer shows the automobiles reviewed by the customer and the length of time customers have devoted to a particular automobile, thereby providing a dealer with information to follow up on the specific interests of the customer.

And another object of the present invention is the provision of methods and systems which encourage the development of a one-on-one sales relationship between the customers and a media personality performing in the video playback on the portable media players/PDAs and in associated promotional advertising encountered outside the dealership. For example, manufacturer, dealer and third party advertising material, as well as rebate information, can be delivered to the customer via the portable media players/PDAs.

And another object of the present invention is the provision of methods and systems which deliver uniform training to all salespersons on the various automobiles through the portable media players/PDAs.

And another object of the present invention is the provision of methods and systems which provide uniform and verifiable presentations on services offered by the dealer, such as finance services, insurance services, and warranty services.

Other and further objects features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a schematic illustration of a system for promoting the sales of automobiles, including a base computer and a plurality of portable media players.

FIG. 2 is a schematic illustration of the internal components of one of the portable media players.

FIG. 3 is a schematic illustration of the opening page display on the portable media players showing the touch screen user interface having a plurality of virtual buttons.

FIG. 4 illustrates a screen of one of the portable media players playing a walkaround instruction file in which an onscreen personality is performing.

FIG. 5A is a schematic illustration of the screen display of the base computer as it tracks the usage of a plurality of portable media players in use by consumers.

FIG. 5B illustrates a screen of an example display of the base computer at the checkout page for checking a portable media player out to a customer.

FIG. 5C illustrates a screen of an example display of the base computer listing in the left hand column the active portable media players that have been checked out to customers.

FIG. 5D is a schematic diagram of the software utilized on the base computer.

FIG. 6 is a schematic illustration of a plurality of base computers in use by different automobile dealerships and the web based network through which those base computers are periodically updated with updated files to be loaded onto the portable media players.

### DETAILED DESCRIPTION OF THE PREFERRED EMBODIMENTS

### System Infrastructure

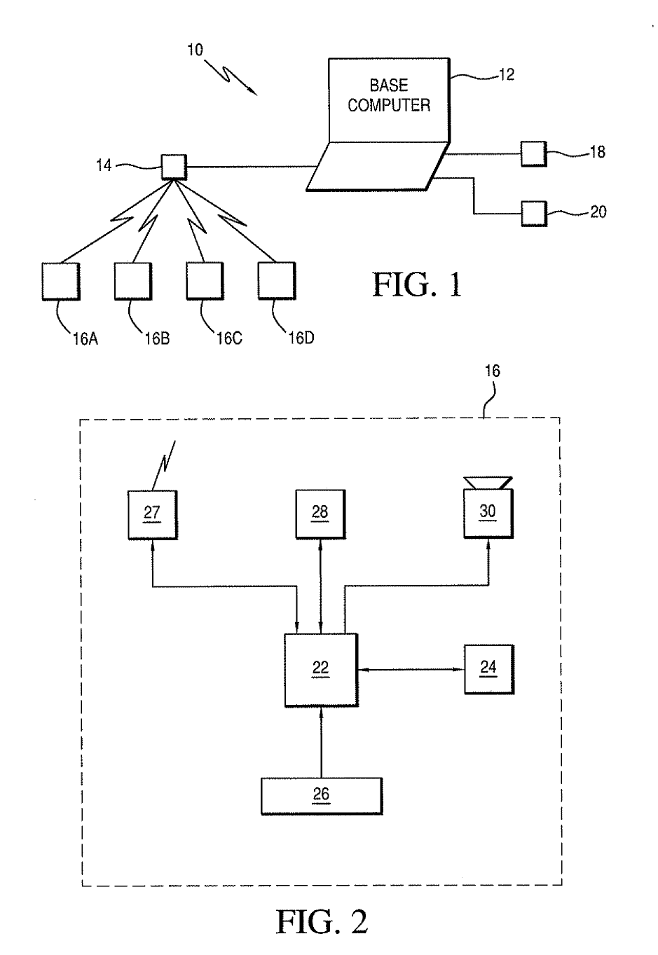

Referring now to the drawings, and particularly to FIG. 1, a system for promoting the sales of automobiles is shown schematically and generally designated by the numeral 10. The system 10 includes a base computer 12 having a wireless card or the like 14 providing a wireless communication capability. The system 10 further includes a plurality of portable media players 16, which have been designated as 16A, 16B, 16C, 16D, etc. in FIG. 1.

The system 10 further includes a document reader 18 which may for example be a card reader which allows a customer's identification document such as a credit card or driver's license to be swiped so that the magnetic stripe on the card is read by the card reader and customer identification information is automatically input into the base computer 12.

The system 10 further includes a docking station or port 20 which allows each of the portable media players 16 to be physically connected to the base computer 12 for synchronization of the files on the portable media players 16 with files and data on the base computer 12. Alternately, the portable media players 16 may receive files from the base computer 12 via a wireless signal. The docking station or port 20 may also provide for recharging of batteries in the portable media players 16.

The system 10 may also be used for sales personnel training and tracking of that training. In this embodiment, the document reader 18 may be designed to read an employee's ID badge. Optionally, the employee may sign in through the base computer 12. The employee may then use one of the portable media players 16 for training purposes. Once a training module is completed, the base computer 12 may record the training in a database. The portable media players 16 used for training sales personnel (or other dealership employees) may be the same or different from those used by customers of the dealership, as described below.

In one preferred embodiment, the base computer 12 may be a conventional personal computer running Microsoft Windows XP with SP2 or Vista operating system software. The base computer 12 is preferably provided with a wireless communication card 14 such as one using the Wi-Fi 802.11b/g format. The portable media players 16 may be Apple® iPod® Touch devices. The Apple® iPod® Touch has a wireless communication capability based upon the Wi-Fi 802.11b/g/n system. In some embodiments, the portable media players 16 may be a smart phone (such as iPhone®), an iPad®, an android-based product, a tablet or the like. The wireless communication capability may be provided on most car lots by a single Wi-Fi based access point with a high gain antenna. For larger car lots it may also be necessary to use one or more repeaters to provide adequate wireless communication to the base computer. The docking port 20 is provided via a cable connection to a USB 2.0 port on the base computer 12. Any other suitable base computer, portable media players, wireless communication formats and document readers may be utilized.

FIG. 2 schematically illustrates the internal construction of one of the portable media players 16. Each portable media player 16 includes a microprocessor 22 operably associated with a memory storage device 24 which may for example be a hard drive. Associated with the microprocessor 22 are user input mechanisms 26 which in the example described comprise virtual buttons on a touch screen. The microprocessor includes a wireless communication capability 27, which in the Apple® iPod® Touch device is Wi-Fi 802.11b/g/n.

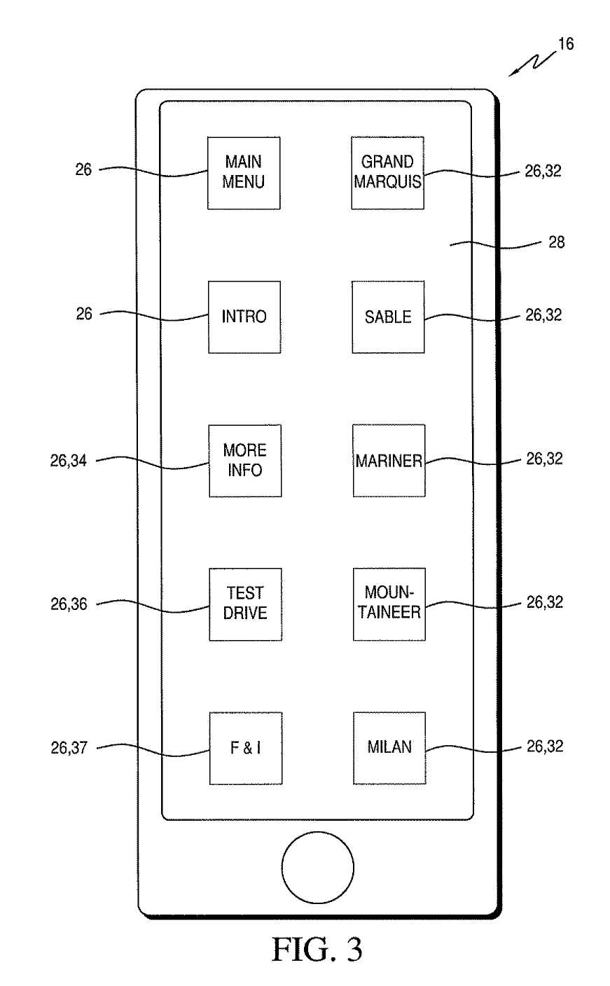

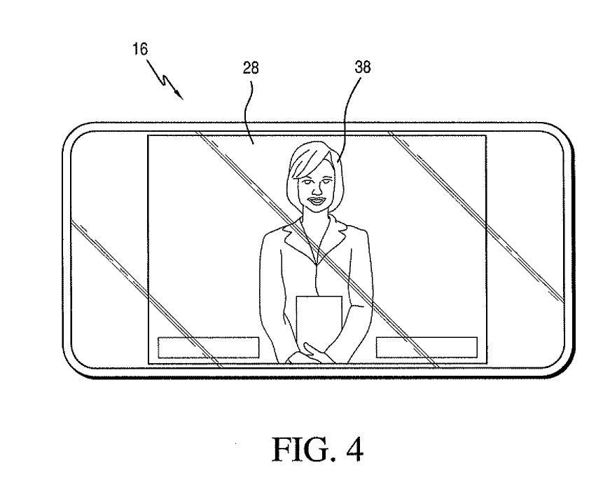

The microprocessor 22 has both video output 28 and audio output 30 associated therewith. In the case of the Apple® iPod® Touch, the video display 28 is provided by the touch screen 28 as seen in FIGS. 3 and 4. The audio output 30 can be via earphones or a plug in speaker adapter utilized with the Apple® iPod® Touch.

As will be further described below, a plurality of files will be stored on the memory 24 of the portable media player 16 and those files will include walkaround instruction files which provide both audio and video instruction to the user to guide the user through a walkaround inspection of an automobile. The files may also provide content in the form of text, picture files. inventory files, vehicle spec data, and the like. The plurality of files may also include sales training files, specifically adapted to aid in the consistent training of sales persons. These sales training files may be the same or different from the files used for customer-users.

Also, in an alternative embodiment the walkaround instruction files could be stored on the base computer 12 and accessed remotely via the wireless communication capability. In some embodiments, certain files may be stored on the portable media player 16 and certain files may be stored on the base computer 12, for download at the user's request. For example, more general information on each make and model of automobile may be stored on the portable media player 16 and more detailed information may be remotely accessed from the base computer 12.

Each of the portable media players 16 includes a user interface which in the case of the Apple® iPod® Touch is the touch screen 28. The user interface 28 includes a plurality of selectable inputs. Those selectable inputs 26 include a plurality of virtual buttons 32 corresponding to various walkaround instruction files each for an identified model of automobile. Thus for example a Mercury automobile dealer might use a touch screen having selectable inputs 32 corresponding to the Grand Marquis, Sable, Mariner, Mountaineer and Milan models of Mercury automobiles. The user interface 28 further includes additional selectable inputs 34 and 36 by means of which the customer can send a wireless signal to the base computer 12 to request salesperson assistance. The virtual button 34 requests “MORE INFORMATION” which would lead to a salesperson joining the customer to answer their questions. The virtual button 36 requests “TEST DRIVE” which would lead to a salesperson joining the customer and bringing the keys to test drive the automobile which the customer is viewing.

When a customer selects one of the selectable inputs 32 to view and hear a walkaround instruction file for the selected model of automobile, video is displayed on the touch screen 28 along with an audio output from the speaker 30.

Preferably the audio and video of the walkaround instruction file are performed by an on-screen personality 38. The on-screen personality 38 preferably is a live human being, but could also be an animated on-screen personality.

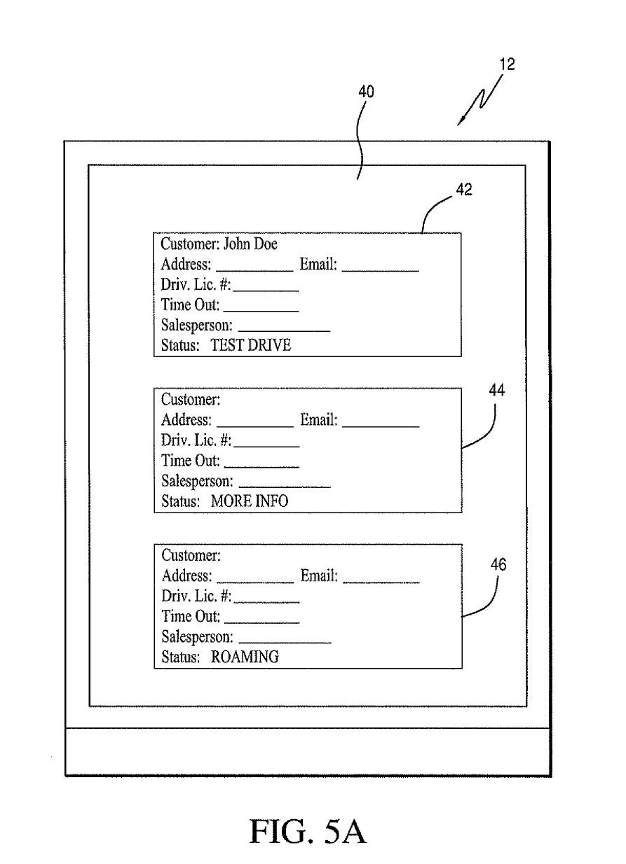

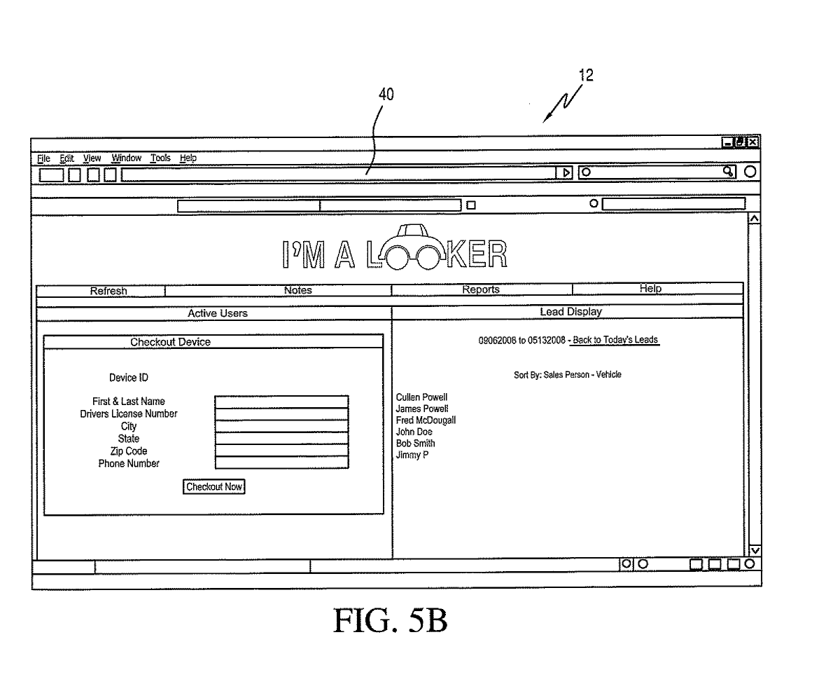

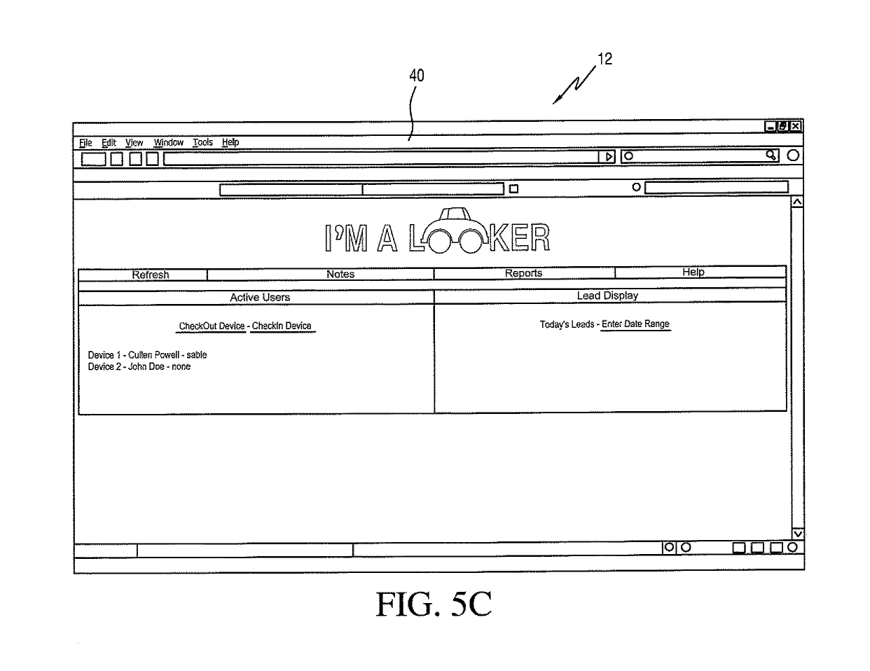

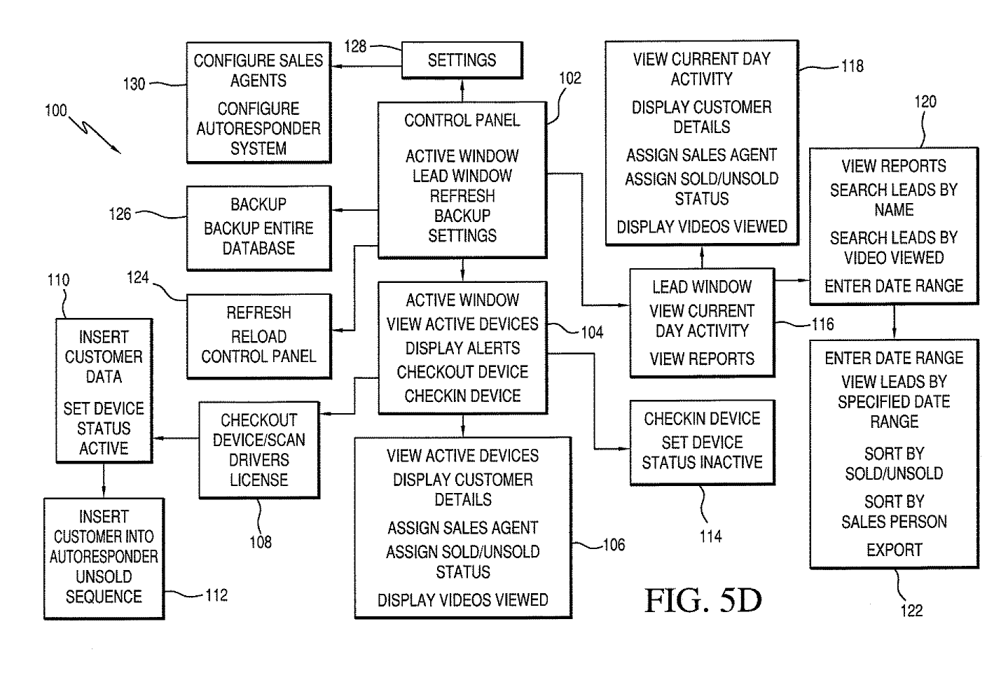

FIG. 5A is a schematic illustration of a typical display which would be seen on the screen 40 of the base computer 12 when the system 10 is in use. The base computer 12 will include software 100 further described below with reference to FIG. 5D. Software 100 provides a control screen display such as that schematically illustrated in FIG. 5A. In the example of FIG. 5A, customer identification information such as 42, 44 and 46 is displayed for three customers currently each using one of the portable media players 16. In each case the information displayed includes customer identification and contact information such as name, address, driver's license number, e-mail address and the like. The information displayed also preferably includes an indication of the time at which the portable media player 16 was checked out to the particular customer.

Preferably the software 100 of the base computer 12 will highlight the information displayed on-screen 40 to indicate whether the customer has requested “MORE INFORMATION” or “TEST DRIVE”. Screen 40 may be referred to as a dispatch dashboard 40. For example, the information might be highlighted in green to indicate that the customer has requested more information, and might be highlighted in red to indicate that the customer has requested a test drive. If the customer has not requested any assistance yet, the customer status is indicated as “ROAMING”. Also, the information may be arranged on the screen in order of priority. For example, the most recent customer to request more information or a test drive might be displayed on the top of the screen. Other information that could be displayed would include the time at which the request for more information or test drive was received from the customer, the name of the salesperson assigned to assist the customer, and the like.

FIG. 5B illustrates a screen of an example display on the base computer showing the checkout screen for use in gathering customer information and checking the device 16 out to the customer. FIG. 5C illustrates a screen of an example display on the base computer showing active status of two devices 16 which have been checked out. The information displayed in FIG. 5C also indicates what walkaround media file is currently being viewed by each customer; for example it indicates that customer Cullen Powell is viewing the file for the Sable model of Mercury automobile.

The software present on the portable media player 16 includes a feature which locks out use of other functions of the portable media player 16 other than those functions which are associated with the use of the portable media player 16 for promoting the sales of automobiles. When the same media player is used for both promoting the sales of automobiles and for training sales personnel, the software present on the portable media player 16 may include a feature which allows certain function for sales training that may not be available for customer use. Thus for example if a portable media player such as the Apple® iPod® Touch is used for the portable media player 16, the software placed on the portable media player 16 would lock out the typical functions utilized to download music videos over the Internet or from a personal computer and to play those music videos. Aside from the fact that such usage is not needed for the intended purpose of the portable media player 16, this will also reduce the temptation for customers to fail to return the portable media players to the dealer.

It is expected that the system 10 of FIG. 1 would merely be one of a plurality of such systems provided to many different automobile dealers who would be participating in a regional or nationwide marketing program. Each of those dealers would periodically receive updated promotional files to be loaded upon their portable media players from a central location.

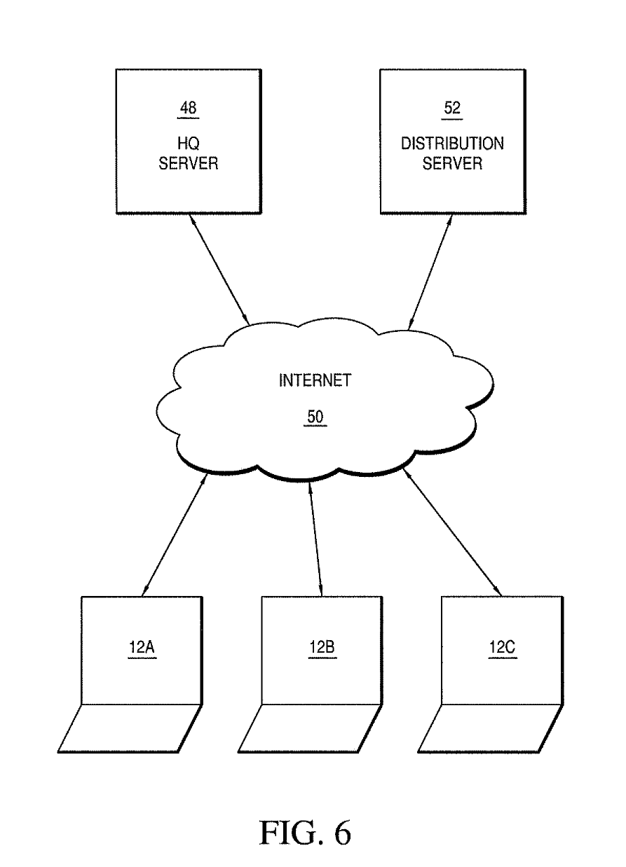

For example, as shown in FIG. 6 the administrator of the program may operate from a headquarters server 48 which communicates over the Internet 50 with a file distribution server 52 which in this instance may for example be the iTunes® server operated by Apple Computer, Inc. Each of the base computers such as 12A, 12B and 12C would in turn communicate with the distribution server 52 over the Internet in a manner further described below.

All of the files to be distributed to the various dealers would be generated by the program administrator and would be sent from the headquarters server 48 to the distribution server 52. The program administrator would place on the distribution server 52 the latest versions of all the files which are to be made available to the various dealers.

Each of the dealers will have a user identification number assigned thereto, which in a preferred embodiment would be embedded in the portable media players provided to that dealer and would not actually be known by the dealer itself. When the dealer's base computer 12 logs onto the distribution server 52, one or more of the dealer's portable media players 16 will be physically connected to the base computer 12. Thus when the dealer logs onto the distribution server 52, the distribution server 52 will recognize the dealer identification number embedded in the portable media player 16, and the dealer's base computer 12 will be permitted to download the latest version of those files to which the dealer is permitted access. Those files would be downloaded over the Internet to the dealer's base computer 12, and in turn from the dealer's base computer 12 to the hard drives of each of the portable media players 16 connected thereto.

The software 100 placed on the dealer's base computer 12 may for example be programmed to cause the base computer 12 to log onto the distribution server 52 at an assigned time, for example midnight, each evening so as to download the latest versions of any programs which may have been modified in the prior 24 hours.

The software 100 placed on the dealer's base computer 12 is designed to be used in conjunction with the portable media players 16 as a backend customer management system and communication hub. It facilitates the management and control of each portable media player 16 as well as storing prospect (customer) information in a database to be used as a means of tracking player 16 usage as well as aiding in the development of sales leads. The software manages and stores the following customer information: customer name, address, driver's license number and phone number, and also tracks which car models each customer views when operating the player 16. Further the software has the ability to assign a sales person to a specific customer and also to set and track any sales developed as a result of the usage of the system 10. The software combines advanced features for reporting and sorting customers via the following specifications: daily, weekly, specified date ranges, by sales person, by specific car models as well as by sorting and reporting whether customers did or did not make a purchase. The software facilitates the process of checking out and checking in each player 16 via a realtime dashboard and also displays any players/customers which are actively checked out or in use. The system further has the capability of assigning custom notes to each customer or prospect entered into the system. Prospects are entered into the system either manually or via scanning the customer's driver's license which automatically inserts the data into the pre-specified fields. The system is built modularly and is not limited to these specifications, thus allowing for the easy addition of future feature sets.

Referring now to FIG. 5D, a schematic outline is there presented of the software 100 which resides on the base computer 12. As indicated in block 102 the software 100 provides a control panel and user interface which controls the display on the screen 40 and through which the user can interact with the base computer 12 via either a touch screen embodiment of the screen 40 or a conventional display screen with other user interface such as keyboard, mouse or the like. As indicated in block 102 the control panel provides various interactions of the user with the base computer 12 via an active window, a lead window, a refresh function, a backup function and a settings function.

As indicated in block 104 the active window of the control panel software allows the user to view active devices, display alerts, checkout devices and checkin devices.

Block 106 provides further details of the “VIEW ACTIVE DEVICES” function of the active window. The screen display of FIG. 5A corresponds to the “VIEW ACTIVE DEVICES” function. The data displayed on screen 40 as illustrated in FIG. 5A can include a display of customer details, an assignment of a responsible sales agent, and the like. Other interaction can include assigning a sold or unsold status to the customer indicating whether they have made a purchase. Other activity can include a display of the listing of the walkaround videos that each customer has viewed while using their portable media player 16.

The “CHECKOUT DEVICE” function of active window 104 is further represented by block 108. As previously noted the checkout of the device will typically include some data entry via scanning a driver's license or other identification document belonging to the customer. In some embodiments, the checkout of the device may include scanning in an employee's ID badge or require some type of employee sign-in, allowing the employee to complete one or more training modules via the portable media player.

As indicated in block 110 there can be further customer data entry after scanning the customer's identification document, and the status for the portable media device 16 issued to the customer will be set as active.

As indicated at block 112, the customer to whom the device 16 has just been issued will then be included in the sequence of “UNSOLD” customers in the active database.

Block 114 represents interaction of the user with the active window 104 during the “CHECKIN DEVICE” procedure. Upon checking in the device the device status is set as inactive and it will drop from the list displayed on the “VIEW ACTIVE DEVICES” window 106.

The control panel window 102 also drives many of the other activities that have previously been mentioned, in addition to checking the portable media devices 16 out and in to active customers and viewing the active devices while the customer is on the sales lot. For example the lead window function as represented by box 116 allows the user to view activity which has occurred during the current day, and also to view various reports which can be generated.

The “VIEW CURRENT DAY ACTIVITY” function is represented by box 118. In that window, the software will display customer details of all of the customers who have used the walkaround media devices 16 during that day. It will indicate the sales agent assigned to the customer or will assign a sales agent if not already done. It will indicate whether the customer purchased an automobile or not. It will allow a review of the videos that were viewed by the customer so as to provide an indication of which models of automobile the customer may be interested in. This data of course can be used to follow up with customers, to see how successful certain sales agents may have been, to assess the overall sales success of the dealership, and to provide an overall assessment of which models are of interest to the customer base so as to provide a focus for future promotions, etc.

The “VIEW REPORTS” function is further explained in box 120. The “VIEW REPORTS” function allows the user to manipulate the data which has been gathered from the multiple customer visits for further study and follow up. For example, it allows a search of the database by name to identify a particular lead to be followed up with and to determine what models were of interest, etc. to that particular customer. It allows a search by video view to create a list of customers that have indicated an interest in certain models. It allows searches to be conducted over any desired date range.

The “VIEW REPORTS” function may also be used to view training reports. With this capability, the management of the automobile dealership may be able to monitor and maintain accurate sales training logs. This may help ensure consistency in the education of the entire sales force as well as alert the management when training has not occurred or when re-training is needed. In some embodiments, the sales promotion aspect of the system and the sales training of the system may be separate modules. In other words, sales persons may be able to access the customer information and view customer reports, while the same sales persons may not have access to training records and reports.

As indicated in block 122 leads can be searched over any specified date range. Leads can be sorted into customers who purchased automobiles and customers who have not yet purchased. Leads can be sorted by sales person. Reports based on these various combinations of data can then be exported for further action.

Returning to the control panel window 102, it also provides a refresh function as indicated at window 124, a backup function as indicated at window 126, and a settings function as indicated at window 128. The settings function as further explained at box 130 allows setup for input of sales agent data and configuration of the auto responder system for responding to calls from the customers utilizing the portable media player devices 16 when they call for further information or for a test drive.

Methods of using the System

The system just described may be used as part of an overall marketing program to which the dealerships subscribe. In other embodiments, the system may be used as part of an overall sales training program. Each participating dealership receives prepackaged television advertising, radio advertising, and print advertising to be distributed by the dealership within its geographic area. The dealership also receives online advertising videos that can be made available to customers via the dealership's website.

This advertising campaign preferably involves performances by the same on-screen personality who performs the walkaround instruction directions on the portable media players.

This advertising promotional campaign advertises to customers the availability at the dealership of the option for the customer to visit the dealership and have self-guided examination of vehicles with the assistance of the portable media players playing instructional videos.

When a customer visits the dealership and indicates that they would like to view the vehicles without salesperson assistance, the customer is provided with one of the portable media players 16.

The customer's identification information is obtained prior to checking out the portable media player 16. For example an identification document of the customer such as a credit card or driver's license may be swiped in a card reader 18 so that the customer's identification information is automatically downloaded to the base computer 12. Some of the information may be obtained automatically by reading the customer's identification document, and some may be entered manually. For example, the customer may be requested to provide an e-mail address to be used in follow up communications, and that e-mail address may be manually entered into the base computer 12.

The customer is also instructed in the manner of using the portable media player 16. The customer is instructed how to select various ones of the walkaround instruction files to provide guided walkaround tours of the various vehicles by touching one of the virtual buttons on the touch screen 28. Some of those virtual buttons may also be assigned to other audio-video files other than walkaround instruction files.

For example, files may be placed upon the portable media player including introductory messages from the dealership or from the manufacturer. For example, an introductory message might be provided from the president of the automobile manufacturing company welcoming the customer to the dealership, etc. Other such files could include point of sale advertising, whether the advertising message comes from the automobile manufacturer, the dealership, or some third party wishing to target a message to the potential automobile purchaser.

The customer may be invited to play those introductory comments as they are walking from the sales desk to the location of the cars to be viewed.

The customer is also instructed that if at some point during their visit they desire the presence of a salesperson to answer questions, they may press the “MORE INFORMATION” button. The customer is also instructed that if they decide they wish to test drive a particular vehicle they can press the “TEST DRIVE” button and a salesperson will come to their assistance and will bring the keys to test drive the vehicle. The portable media player 16 will transmit a wireless message to the base computer 12 that may for example include both an audio and a text message stating “MR. JONES IS PREVIEWING THE SABLE AND IS REQUESTING TEST DRIVE”.

The customer carries the portable media player and walks to the location of the vehicles and begins to view the vehicles as desired. When the customer approaches a particular vehicle for which they would like to receive detailed information, they press the input button 26 corresponding to the vehicle in question. In response to that customer input, the portable media player 16 plays the corresponding walkaround instruction file. Typically that playback will include a video display of the on-screen personality who talks to the customer and tells them how to examine the vehicle. Excerpts of the text of such a presentation for a Ford F150 pickup truck might, for example, read as follows:

“HELLO, I'M LENA. I AM LOOKING FORWARD TO SPENDING SOME TIME WITH YOU ON THE 2008 FORD F150 FX4 4 BY 4. I THINK YOU WILL ENJOY OUR TIME TOGETHER AND I KNOW YOUR GONNA BE IMPRESSED WITH THIS TRUCK. BEFORE WE START IF AT ANYTIME DURING MY PRESENTATION YOU HAVE ANY QUESTIONS OR NEED ASSISTANCE AT ANYTIME SIMPLY PRESS THE INFORMATION BUTTON AND A REPRESENTATIVE WILL RESPOND.

NOW LETS GET TO THE FUN PART. PLEASE PROCEED TO THE DRIVERS DOOR OF THE F150 FX4. I WANT TO SHOW YOU WHY THE F150 HAS BEEN THE #1 SELLING LINE OF TRUCKS FOR 30 YEARS IN A ROW. 30 YEARS! WOW. NOW THATS A LONG TIME TO BE #1 AND THE GREAT THING IS THE F150 JUST CONTINUES TO GET BETTER. AS YOU ARRIVE AT THE DRIVERS DOOR PLEASE OPEN THE DOOR AND JUST INSIDE THE F150 YOU WILL FIND THE HOOD RELEASE LEVER. IT IS LOCATED ON THE BOTTOM LEFT PANEL NEAR THE PARKING BRAKE. DID YOU FIND IT? IT HAS A PICTURE OF A HOOD ON IT? GO AHEAD AND PULL THIS LEVER AND IT WILL POP THE HOOD.

WHILE WE ARE IN THIS AREA GO AHEAD AND OPEN THE REAR DOORS AND LOOK AT THE TREMENDOUS SPACE THE PASSENGERS IN THE BACK WILL ENJOY. THE F150 EXTENDED CAB OFFERS MORE HIP AND SHOULDER ROOM THAN THE CHEVY SILVERADO. THE ANGLE OF THE SEATS IS A COMFORTABLE 21 DEGREES, WHICH IS SIMILAR TO THE TYPICAL ANGLE OF THE FRONT SEATS. THIS WAY THE BACK SEAT CUSTOMERS CAN BE COMFORTABLE AND NOT FEEL LIKE THEY ARE SITTING STRAIGHT UP. THESE SEATS ARE A 60/40 DESIGNED SPLIT BENCH SEAT. THIS MEANS YOU CAN FOLD THE SEAT UP ALL OF IT OR IN PART AND F150 SUPERCAB GIVES YOU ADDED SPACE FOR STORAGE. MY FAVORITE FEATURE IN THIS AREA IS THE POWER WINDOWS IN THE 2ND ROW. FORD F150 WAS THE FIRST PICKUP TO OFFER THIS ON A SUPERCAB PICKUP. I THINK YOU WILL NOTICE THROUGHOUT THE PRESENTATION THAT FORD HAS THOUGHT OF EVERYTHING AND CONTINUES TO LEAD THE WAY WITH THIS AWARD WINNING F150.

REMEMBER IF YOU NEED ANY ASSISTANCE OR SIMPLY HAVE A QUESTION JUST PUSH THE INFORMATION BUTTON AND A REPRESENTATIVE WILL BE OUT TO ASSIST YOU.

( . . . PRESENTATION CONTINUES WITH DESCRIPTION OF OTHER FEATURES)

IT IS NOW TIME FOR YOU TO ENJOY WHAT THE MAJORITY OF TRUCK BUYERS HAVE ENJOYED DRIVING FOR THE LAST 30 YEARS. PRESS THE TEST DRIVE BUTTON NOW AND LET THE FUN BEGIN.

UNTIL YOUR REPRESENTATIVE RESPONDS I WOULD LIKE TO TELL YOU ABOUT THE WARRANTY ON F150. EVERY NEW F150 FORD WANTS YOUR F150 OWNERSHIP EXPERIENCE TO BE THE BEST IT CAN BE. YOUR NEW F150 COMES WITH 3 YEAR OR 36,000 MILE BUMPER TO BUMPER COVERAGE AND 5 YEAR OR 60,000 MILE POWER TRAIN COVERAGE. YOU'LL ALSO BE GLAD TO KNOW THAT FORD HAS EXTENDED THE ROADSIDE ASSISTANCE COVERAGE FOR 5 YEARS OR 60,000 MILES SO YOU HAVE THE SECURITY OF KNOWING THAT HELP MAY BE ONLY A PHONE CALL AWAY IF YOU RUN OUT OF FUEL, LOCK YOURSELF OUT OF THE VEHICLE, OR NEED TOWING.

NOW I KNOW WE HAVE COVERED A LOT OF FEATURES ON FX4 AND WELL I HAVE ENJOYED OUR TIME TOGETHER AND I AM NOT GOING TO LEAVE YOU. I WILL SEE YOU A LITTLE LATER IN THE PROCESS AND LOOK FORWARD TO VISITING WITH YOU AGAIN AFTER YOU COMPLETE YOUR PURCHASE.”

Through this manner of presentation, the customer is encouraged to develop a relationship with the on-screen personality which will be built upon by further video contacts as described below.

If at some point during or after one of the walkaround instruction file playback sessions the customer has additional questions which they would like to discuss with a human salesperson, the customer may push the “MORE INFORMATION” button which will send a wireless signal to the base computer 12, which will in turn indicate on its display screen 40 that a customer is requesting assistance. The base computer 12 may also issue other alerts such as an audio alert. The salesperson will then visit with the customer and through face-to-face interaction respond to the customer's questions.

Also, if the customer presses the “TEST DRIVE” button 36 this will send a wireless signal to the base computer 12 for which an indication will be displayed once again on the computer screen 40. Again, a salesperson will visit the customer to respond to their questions and in this instance will bring the keys so as to expedite the customer's test driving of the vehicle.

The portable media player 16 preferably will pause the video when a message is being sent for more information or test drive. Once the message is sent, a dialog box “MESSAGE SENT DO YOU WANT TO CONTINUE WITH PRESENTATION” with an “OK” and a “CANCEL” button will appear. Such a message can also be played via audio. At any time the customer will have access to a “MAIN MENU” button to go back to the list of models.

When the customer has requested assistance the system can optionally send back to the customer a message that displays on the portable media player screen such as “HELP IS ON THE WAY”.

In those situations where a customer decides to purchase an automobile, the portable media player 16 may also be used to expedite the purchase process or to otherwise improve that experience. For example, further playback files can be stored on the portable media player 16 to provide information to the customer who is purchasing an automobile about financing and insurance options available at the dealership. This file may also be played in response to an input on the touch screen 28 such as via a virtual button 37 for playback of financing and insurance information. In addition to making F&I presentations more efficient for both the dealership and the customer, a simple verification that such a video was played for the customer creates an accurate record of the exact information that was provided to the customer in case there is later any question about whether and how such options were explained to the customer.

The system just described can also be used to assist the dealership in following up with customers whether they purchase a vehicle or not. A variety of follow up video emails may be created, each of which preferably involve a performance by the same on-screen personality who performed both the promotional advertising that the customer may have seen prior to the dealership visit, and who performs the walkaround instruction videos on the portable media player.

These follow up video e-mails for customers who purchase an automobile may address issues such as customer surveys, a plea for a good survey response from the customer when receiving customer survey requests from the manufacturer, requesting referrals from the customer, and reminding the customer about service intervals and the like.

Customers who did not purchase a vehicle may receive video e-mails addressing subjects such as an invitation to return to the dealership for additional visits, a survey as to why the customer left the dealership without purchase, providing various incentives for returning to the dealership, and other follow up pleas to the customer to maintain the relationship with the dealer.

The system just described along with its integrated promotional campaign is designed to introduce customers to the dealership and bring those customers to the dealership. It develops a nonconfrontational but effective selling environment for the customers, and provides follow up with the customers after the visit. It is designed to improve sales by providing a more pleasant sales environment for certain customers who prefer to minimize the initial face-to-face contact with salespersons thus increasing sales to that segment of the buying public. The controlled presentation of financing and insurance information to customers who do make a purchase can improve revenues from those peripheral activities. The follow up programs aid in developing future business from those customers and from referrals.

A dealership that subscribes to the program is provided with the hardware and software components of the system 10 illustrated in FIG. 1. The dealer is provided monthly comprehensive customized marketing and advertising support materials and services. The dealer is provided assistance in developing their website to use the program materials and to develop customer referrals from the website. In-house training and support is provided to the dealer's sales personnel. A customized welcome video is provided on the portable media player 16 which is customized to the particular dealership. The financing and insurance presentation provided on the portable media player 16 can be customized and focused on the features and benefits of the particular dealership's after market products. The video e-mails that are provided for follow up provide an effective bridge between the dealer's website and customers who prefer to obtain information from the website, thus creating an effective way to draw Internet leads to the dealership and to follow up with them.

The particular walkaround instruction files which the customer views on the portable media player 16 are designed to provide the customer with information on all the features and benefits of the vehicles without negotiating the purchase price at that point. This in many ways makes walkaround presentations via the portable media device 16 more effective for the dealership because a means is provided for conveying to the customer information about the features and benefits of the vehicle without having to deal prematurely with questions from the customer about pricing and the like.

Furthermore, through use of the portable media players and the walkaround instruction files contained thereon, the walkaround presentation of the vehicle is completely controlled. In fact, the walkaround presentation can be designed with input from the vehicle manufacturer so as to ensure that an optimized presentation of the features and benefits of a particular vehicle are provided to each and every customer who visits the dealership and looks at that particular vehicle.

In addition to providing a self-guided walkaround tour of the automobile, the portable media players provide a mechanism for delivering point of sale advertising of various types directly to the customer while the customer is in the middle of making a purchase decision. This opens an entirely new path for targeted advertising that is of great value, and can provide an additional revenue stream to the administrator and/or users of the system 10. The advertising may be in the form of a message from the automobile manufacturer promoting the sales of the automobiles featured in the walkaround instruction files. It may be a message from the dealership promoting the sales of accessories or related services. It may be a message from a third party promoting the sales of goods or services related to the ownership of the automobile. These advertising messages may be incorporated in the walkaround instruction files or they may be in the form of separate files that are played in response to a separate input via the touchscreen controls. This advertising technique allows both audio and video advertising content to be presented to the customer while the customer is located at the side of the vehicle on a car lot, which is something no other advertising media to date has been capable of doing.

This new form of advertising is the first in the automotive industry that can deliver a message directly to a consumer and takes place when the customers arrive at the point of purchase at the vehicle itself. This is the place where the buying decision will ultimately be made. Manufacturers of automobiles have in the past always left this up to the dealers and their salesman to persuade the customer when on the lot to their brand of vehicles. This form of advertising gives the individual dealer as well as the product manufacturer or any other marketer the opportunity to deliver a unique and timely message at the point of sale at the site of the car.

Shopper marketing is becoming an increasing focus for many of the world's major brands. A 2007 study conducted by Deloitte in the United States suggests that the portion of marketing budgets devoted to point of purchase activity doubled from 3% in 2004 to 6% in 2007 and is expected to reach 8% by 2010. We believe the present system will increase that budget in the automotive and sales industries respectively. These increases in spending are because the traditional means have become more difficult and less effective. Media audiences have fragmented among myriad channels, both digital and traditional, and people who have been empowered with the ability to filter many forms of communication are increasingly annoyed by unsolicited advertising intrusions that don't apply to them.

The present system delivers at the point of sale when a customer is shopping for a vehicle. There is a tremendous gap between out of store marketing (Example National advertising campaigns including television. radio, online advertising, mail etc) and in store marketing. This is sometimes due to the fact that each dealership acts as an independent agent and the communication between manufacturer and dealership is not always good. This lack of coordination between out of store and in store marketing can be confusing to shoppers. The present system ties together these campaigns and aligns the dealership and manufacturer into one advertising message and channel. The present system brings a new form of media advertising. A customer using the device 16 is in a different mindset than when they are watching television or reading. The shopper is at a dealership asking to be informed and learn more about the product. One form of in store marketing is television display in store that delivers a form of advertising. The present system 10 has a different effect because the device 16 is handheld and more direct to that customer. In an ever increasingly competitive market this unique advertising opportunity gives marketers the ability to reach out further and appeal to a more focused customer.

Furthermore, the walkaround instruction presentations that are played back on the portable media players 16 can be utilized to train sales personnel at the dealership as to how to make a perfect in person walkaround presentation of each vehicle model. The sales personnel may sign into a main computer system to use these players. The media players will send (for example, wirelessly or when docked to the main computer system) a record of completion of the training to the main computer system to track sales personnel training. The main computer system may further include features for testing sales personnel, prompting for periodic retraining (for example, at the introduction of a new model year), and alerting the automobile dealership when training goals have or have not been met. The training may include any training related to the particular roles and responsibilities. For example, the training may include training on the features of the cars on the dealership lot (by, for example, viewing the media player in the same manner as a customer). The training may also include internal dealership-based media training (videos not available to the customers), such as service department training, financing training, incentive training, and the like. The base computer may include a training input screen, where management, or other designated persons, may enter required and/or optional training modules for one or more of the sales personnel. The training input screen may also include a desired completion date field, for entering a desired completion date. The base computer may generate a report for each of the sales personnel, detailing his or her required training and its respective due dates for completion.

The system builds customer traffic to the dealership in several ways including:
1. It provides a web-based lead generator;
2. It raises appointment percentages for the dealer's Internet department;
3. It gives the dealer a completely unique lead follow up response that is different from competing dealers;
4. Advertising separates the dealer from the competition;
5. Advertising of this unique self-guided walkaround examination option directs customers to the dealership; and
6. The advertising is focused on benefits and not on loss leader sales prices.

Throughout the sales experience sales are enhanced in a number of ways including:
1. A perfect vehicle walkaround is provided each and every time;
2. The system extracts customer information from the customer in a nonconfrontational way;
3. The system sells vehicle benefits prior to price negotiations;
4. The system assists salespeople in product knowledge development;
5. The system ensures financing and insurance disclosure compliance and ensures that all the dealership's after market products receive proper and effective presentation; and
6. The system provides effective financing and insurance menu presentation thus increasing back end profits and penetration.

The system further provides improved follow up with customers in a number of ways, including:
1. Ensuring consistent and proper follow up when the customer leaves the lot;
2. Bringing the customer back to the dealership without resorting to lowball offers or false promises;
3. Ensuring good manufacturer surveys or remedies to receive one; and
4. Implementing an effective referral system with each and every customer.

Particularly for the younger generation of consumers who are very comfortable with and often prefer an Internet purchasing experience to a face-to-face purchasing experience, the system described provides the ability to combine an Internet-like purchasing experience with the opportunity for on site visit and examination of the automobiles which is so important to such an important and expensive purchase decision. Thus the best aspects of online shopping and on site shopping are combined.

Thus it is seen that the systems and methods of the present invention readily achieve the ends and advantages mentioned as well as those inherent therein. While certain preferred embodiments of the invention have been illustrated and described for purposes of the present disclosure, numerous changes in the arrangement and construction of components and steps may be made by those skilled in the art, which changes are encompassed within the scope and spirit of the present invention as defined by the appended claims.

What is claimed is:

1. A method of promoting the sales of automobiles, comprising:
(a) displaying menu options to a customer on a portable user interface;
(b) permitting the customer to selectively play one or more walkaround instruction files so that the customer may engage in one or more guided walkaround examinations of vehicles without the presence of a salesperson; (c) displaying a menu option to send a wireless signal requesting salesperson assistance by face-to-face interaction of a salesperson with the customer when selected from the menu options displayed to the customer; and
(d) displaying a menu option to send a wireless signal requesting a test drive when selected form the menu options displayed to the customer.

2. The method of claim 1, further comprising:
prior to step (a), receiving customer identification information and customer contact information from the customer.

3. The method of claim 2, wherein:
the receiving customer identification information step is performed at least in part by reading the customer's identification document with a document reader.

4. The method of claim 1, wherein the walkaround instruction files are stored on a memory device included in the portable media player.

5. The method of claim 1, further comprising:
in response to an input via the user interface, playing an introductory message to the customer via the portable media player.

6. The method of claim 1, further comprising:
in response to a customer input via the user interface, playing one or more of the walkaround instruction files to the customer via the portable media player.

7. The method of claim 1, further comprising:
in response to an input via the user interface, playing a message regarding financing and insurance options to a customer who has decided to purchase an automobile.

8. The method of claim 1, further comprising:
in response to an input via the user interface, playing a point of sale advertising message to the customer.

9. The method of claim 1, wherein the walkaround instruction files contain both audio and video content.

10. The method of claim 1, wherein the user interface comprises a touch screen video display.

11. The method of claim 1, including providing the information to the media player from a base computer which shows the automobiles reviewed by the customer and the length of time the customer has devoted to a particular automobile.

12. The method of claim 1, wherein the method is part of a system having a plurality of different automobile dealers who received information for the media players from a central location.

13. The method of claim 15, wherein the information from the central location is conveyed by a headquarters server which communicates over the internet with a file distribution server which communicates with a base computer at each automobile dealer.

14. A system for promoting sales of automobiles, comprising:
a base computer having a wireless communication capability; and
a plurality of portable media players, each portable media player having a wireless communication capability and including a user interface including:
a plurality of selectable inputs each corresponding to a walkaround instruction file for an identified model of automobile, so that a customer may select playback of one or more of the walkaround instruction files;
a first selectable input for sending a wireless signal to the base computer to request salesperson assistance; and
a second selectable input for sending a wireless signal to the base computer to request a test drive of the identified model of automobile

15. The system of claim 14, wherein:
the user interface of each portable media player comprises a touch screen, and the selectable inputs are defined by virtual buttons displayed on the touch screen.

16. The system of claim 15, wherein:
the first and second selectable inputs are defined by an additional virtual button displayed on the touch screen.

17. The system of claim 14, wherein:
the walkaround instruction files are stored on a memory device included in each portable media player.

18. The system of claim 14, wherein:
the walkaround instruction files contain both audio and video content including the image and voice of an on-screen personality.

19. The system of claim 14, wherein:
the portable media players include software which locks out use of functions of the portable media player other than those functions associated with the use of the portable media player for promoting the sales of automobiles.

20. The system of claim 14, including a docking station for allowing each media player to be physically connected to the base computer for synchronization of the files on the media players with files and data on the base computer.

21. The system of claim 14 wherein the base computer is a personal computer having a wireless communication card, the media player including a microprocessor operably associated with a memory storage device and with user input mechanisms, the microprocessor including wireless communication capability, microprocessor having video output and audio output, a plurality of files stored on the memory storage device, each of the portable media players including the user interface in the form of a touchscreen and the selectable inputs including virtual buttons corresponding to the various walkaround instruction files for each of the automobiles, and one of the virtual buttons requesting a test drive.

22. The system of claim 14 wherein the base computer includes a screen for displaying customer identification information for the customer using a media player and for displaying customer contact information and for displaying an indication of the time at which the portable media player was checked out.

23. The system of claim 22 wherein information on the base computer screen is highlighted in different colors, the base computer screen indicating when a customer has not yet requested assistance, the customer screen containing its information in an order of priority wherein the most recent request for more information or a test drive is given top priority, the base computer screen displaying the time at which a request for more information or test drive was received and displaying the name of the sale's person assigned to the customer, and the base computer screen displaying checkout information and indicating what walkaround media file is currently being used by each customer.

24. The system of claim 14 wherein the base computer includes software for providing a back end customer management system and communication hub, the software managing and storing customer information including which car models each customer views when operating a player, the software having the capability to assign a sales person to a specific customer and to track any sales developed as a result of the usage of the media player, the software providing for reporting and sorting customer's during a time range that software being capable of reporting customer information by sales person and specific car models and as to whether the customer made a purchase, the software checking out and checking in of each media player and displaying which media players are actively checked out or in use, and the software being capable of having custom notes for each customer.

25. The system of claim 14, wherein the software provides a control panel and user interface which controls the display on the base computer screen and through which the user can interact with the base computer, the software including an active window of the control panel software to allow the user to view active devices and to view display alerts and to view check out devices and to view check in devices, the software providing details of the customer and the assignment of a responsible agent for the customer, the software including an active window to drop from an active status media players which are inactive, and the software including a viewing of current day's activities and including a view report function to provide data which has been gathered from multiple customer visits and including a control panel window and including a box for setting the input of sales agent data and configuration of the auto responded system for responding to calls from the customer utilizing the media players.

26. The system of claim 14 wherein the base computer and portable media players are part of a multidealer system wherein each of the participating dealers includes a base computer and its associated media players including a headquarters server which communicates over the internet with a file distribution server which in turn communicates with each of the base computers.

27. A method for training automobile sales personnel, comprising:
(a) prompting the sales personnel to sign into a base computer;
(b) displaying menu options to the sales personnel on a portable user interface assigned to the sales personnel by the base computer;
(c) permitting the sales personnel to selectively play one or more walkaround instruction files so that the sales personnel may engage in one or more guided walkaround examinations of vehicles;
(d) sending a signal to the base computer when sales training on a particular vehicle is completed by viewing one or more of the walkaround instruction files; and
(e) logging the competed sales training into the base computer.

28. The method of claim 27, further comprising generating reports via the base computer, the reports showing training records of the sales personnel, the reports further showing scheduled training required for the sales personnel.

29. The method of claim 27, further comprising prompting a user to entire desired training and training dates for the sales personnel.
